(19) United States
(12) Patent Application Publication
(10) Pub. No.: US 2026/0131643 A1
(43) Pub. Date: May 14, 2026

(54) Rigid Panel Tonneau Cover

(71) Applicant: Joseph Luke Balay, Sugarloaf, PA (US)

(72) Inventor: Joseph Luke Balay, Sugarloaf, PA (US)

(21) Appl. No.: 18/831,423

(22) Filed: Feb. 21, 2025

Related U.S. Application Data
(60) Provisional application No. 63/556,642, filed on Feb. 22, 2024.

(51) Int. Cl. B60J 7/16

(52) U.S. Cl. CPC B60J 7/1607

(57) ABSTRACT

A tonneau cover constructed of rigid panels allowing removal of each individually to carry larger items within a vehicle bed. Each panel is singularly connected from the interior eliminating the need for addition locking to secure items within. Panels can be removed and transported within the vehicle bed while hauling larger items. The interior structure of the panels uses strut shaped extrusions allowing additional gear and gear storage to be mounted to the interior while increasing the load carrying capacity. The rigid panel tonneau cover provides structural capacity for hauling additional gear, tents and rack systems with a top surface free of lock or hinge protrusions.

### CROSS REFERENCE TO RELATED APPLICATIONS

Provisional patent application Ser. No. 63/556,642

### PRIOR ART

U.S. Pat. No. 6,883,855B2 Hinged tonneau cover for transporting a significant top load
U.S. Pat. No. 9,925,853B2 Load bearing tonneau structure
U.S. Pat. No. 10,328,778B2 Load bearing tonneau cover with integral track, improved latch to vehicle and custom frame attachment
U.S. Pat. No. 8,511,736B2 Rigid tonneau cover and clamp mechanism therefore
U.S. Pat. No. 10,414,256B2 Dynamically configurable tonneau cover
U.S. Pat. No. 6,340,194B1 Hard truck bed cover
U.S. Pat. No. 11,299,021B2 Multi-panel tonneau cover

### BACKGROUND OF THE INVENTION

Tonneau covers are used to enclose the bed of a vehicle and protect items stored beneath from theft and the elements. Some existing covers allow access to the vehicle bed through the top using lids, but this access is eliminated when carrying gear on top of the cover or when of a vehicle rack is added. The addition of lids for access introduces problems with hinges or locks exposed on the top surface. This can be problematic when loading or carrying additional gear. The exposed hinges and locks also prevent direct attachment of gear and other items such as roof top tents requiring the addition of a rack system to suspend them from the top surface of the cover to attach them to the vehicle. The shape of the cover in most current offerings follows the bed rails and gets wider as they get closer to the cab or front of the vehicle. This requires any additional rack system to change in width from front to rear to fit with these covers.

Most of the existing covers in the market can be opened to provide partial use of the vehicle bed when required to carry loads that will not fit beneath the cover. While providing partial bed use, these options must be entirely removed to allow full vehicle bed use. When removed from the vehicle, they cannot be easily carried in the vehicle bed or vehicle itself. Therefore, the cover needs to be removed prior to taking trips to haul larger loads.

### SUMMARY OF THE INVENTION

Examples herein describe a tonneau cover design attached to a vehicle bed to protect gear within the bed from theft and the outside elements while providing additional gear carrying capacity on top. The present invention improves upon this benefit by eliminating the need and complexity of hinges and locks required for covers constructed with lids.

The novel design does not require exterior mounted hinges or locks which improves the aerodynamic benefits of the tonneau cover being added to a vehicle. The enclosed embodiments further benefit aerodynamics with the geometry of the tie down brackets by minimizing their profile and keeping them below the top of the panels.

The cover is rigidly attached to the vehicle on the interior of the vehicle bed with the gear protected when the tailgate is closed, and the vehicle is locked. This is accomplished using the locking installed on the vehicle bed and tailgate from the manufacturer.

Most existing covers are not structural enough to carry additional gear or equipment on top of them. While some options provide access to the vehicle bed through the top, this benefit is eliminated when additional gear is carried on the cover or when there is a rack system used in conjunction with the cover. The present invention consists of rigid panels, provides the structure and load carrying capacity while allowing full bed use and vehicle storage of the cover when removed.

The panels of the present invention are designed to fit together into a series of water diversion channels to prevent any moisture from entering the bed of the vehicle. The diversion channels run the width of the vehicle bed to allow water to flow freely in either direction. The water diversion channels also provide structure to the panels helping support loads carried on top of the tonneau cover.

Structural members added to the interior of the tonneau cover further enhance the load carrying capacity. They can also be used to attach or retain gear within the vehicle bed. This eliminates the need for additional mounting channels to attach and carry equipment beneath the cover.

Each of the panels are individually attached to the rail of the vehicle bed and can be easily removed from the vehicle when desired to allow hauling of taller items. Each of the rear panels can be removed and stacked on the panel closest to the cab. If full bed access is required, all the panels can be removed and stored in the vehicle or vehicle bed. They can also be carried in the rear seat area of a double or crew cab vehicle due to the width in most cases.

Each panel weighs less than 35 lbs to allow users to remove them singularly as desired. In the enclosed embodiments, 3 panels are shown to cover the vehicle bed, but the qty of panels can increase or decrease as required to cover longer or shorter vehicle beds. The panel width can alternatively be changed to cover longer bed lengths and maintain this lightweight benefit.

### BRIEF DESCRIPTION OF FIGURES

FIG. 1—Isometric view of the Rigid Panel Tonneau Cover on a vehicle bed

FIG. 2—Isometric view of the Rigid Panel Tonneau Cover with ⅓^{rd} vehicle bed access

FIG. 3—Isometric view of the Rigid Panel Tonneau Cover with ⅔^{rd} vehicle bed access

FIG. 4—Isometric view of the Rigid Panel Tonneau Cover with full vehicle bed access

FIG. 5—Isometric view of the Rigid Panel Tonneau Cover

FIG. 6—Isometric detail view of the Rigid Panel Tonneau Cover

FIG. 7—Isometric view of a single panel

FIG. 8—Side view of the Rigid Panel Tonneau Cover

FIG. 9—Side detail view of a single panel

FIG. 10—Bottom view of the Rigid Panel Tonneau Cover

FIG. 11—Isometric view of the Rigid Panel Tonneau Cover on a vehicle bed

FIG. 12—Isometric view of the Rigid Panel Tonneau Cover with ⅓^{rd} vehicle bed access

FIG. 13—Isometric view of the Rigid Panel Tonneau Cover with ⅔^{rd} vehicle bed access

FIG. 14—Top view of the Rigid Panel Tonneau Cover

FIG. 15—Section view of a water diversion channel

FIG. 16—Isometric view of the Rigid Panel Tonneau Cover with structural channels shown

FIG. 17—View of the structural channel with tonneau clamping attachment, down position

FIG. 18—View of the structural channel with clamping attachment, up position

FIG. 19—Isometric view of the clamping attachment and its components

FIG. 20—Isometric view of a water diversion component

### DETAILED DESCRIPTION OF THE INVENTION

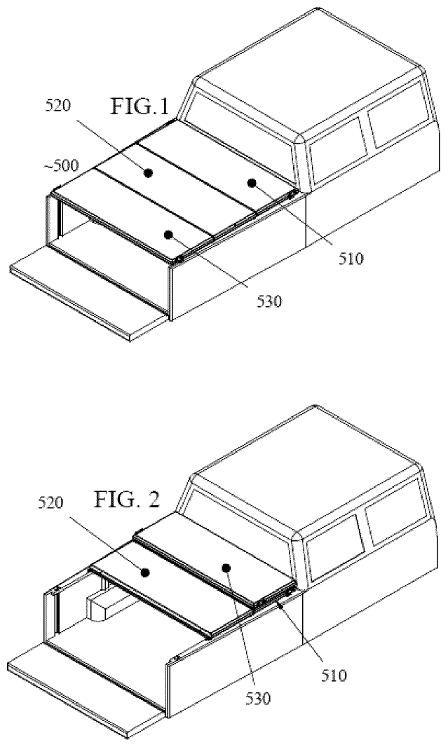

The Rigid Panel Tonneau Cover 500 of the disclosed embodiments includes a front panel 510, a center panel 520 and a rear panel 530, FIGS. 1 & 5 & 11. The rigid panels allow for multiple options for hauling loads. As displayed, the cover is built using Aluminum sheetmetal, brake formed and welded. Aluminum was chosen for its light weight and corrosion resistance without additional treatments. Variations can be made with other materials, and/or other thicknesses, such as steel or fiberglass. Combining extrusions as a perimeter with panels is another optional method of construction. The current method provides less joints further limiting the potential for moisture intrusion.

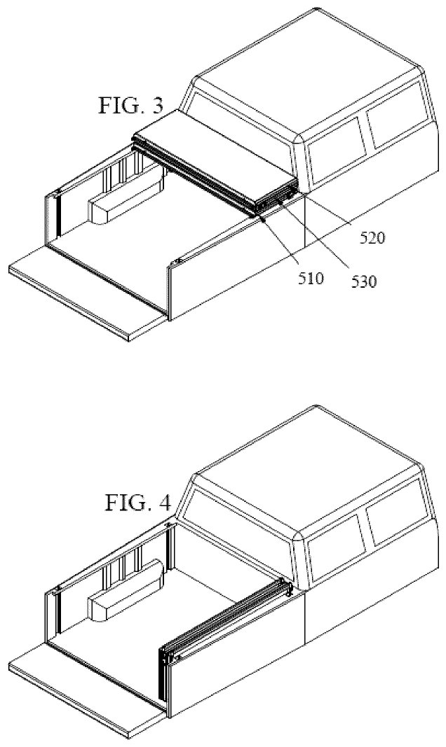

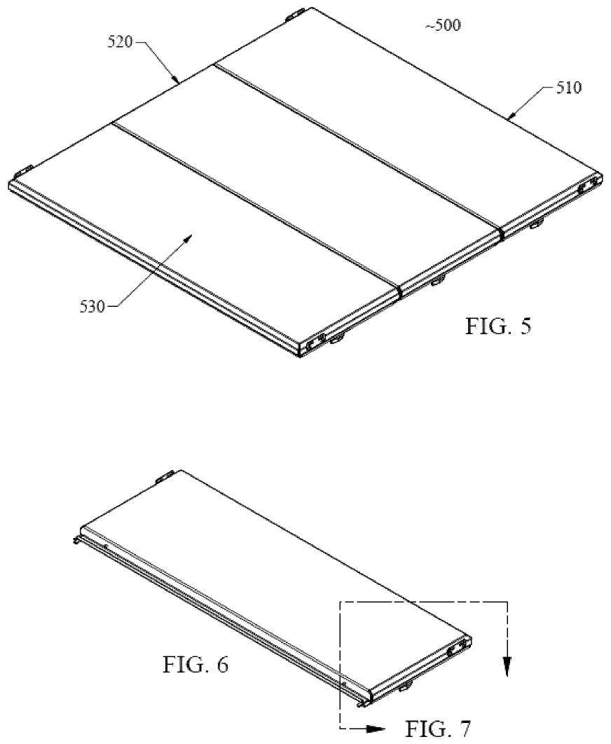

Each panel is individually attached to the vehicle bed. This allows the panels to be removed individually from the rear of the vehicle to carry gear that will not fit underneath the cover as shown in FIGS. 2-3 & 12-13. This ability is further enhanced by removing all the panels for full vehicle bed access. The panels are designed with a length that will allow them to be fully removed from the top of the vehicle bed and stored in the vehicle bed while transporting larger loads, FIG. 4.

The width of the panels is such that it allows them to be removed and carried in the bed of the vehicle lengthwise, from cab to tailgate, FIG. 4. Another possible method is to carry them in the cab of a double or crew size vehicle. These embodiments are typical representations and are not intended to be limiting to the use of the invention.

The panels 510, 520 and 530 are all the same width shown in FIG. 14 to allow them to stack on one another when partially uncovering the vehicle bed. This rectangular geometry also allows a simple design for any rack systems where the front and rear are the same width.

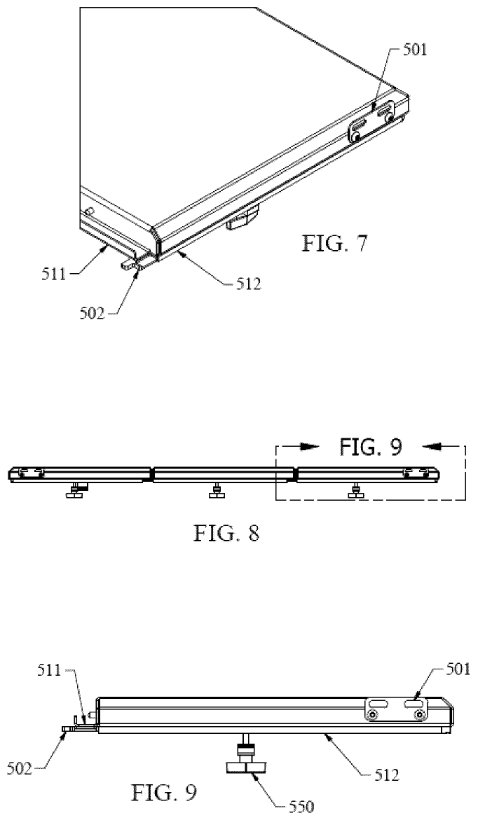

Both the 510 and 520 panels have a water diversion channel 511 formed on one side, FIG. 6-7. This channel is used to divert any water that enters the joint between the panels, FIG. 8-9. The structure of the panels is also improved with the channels by supporting the next panel as shown in FIG. 14-15. The current construction method does not have seals at the panel joints 572 shown in FIG. 15. These seals can be added to provide additional waterproofing if desired. The same water diversion channel engagement occurs between panels 520 and 530 as well.

The panels and formed channels combine with water diversion components 502 at the end of each channel, FIG. 20, also shown attached to the panels in FIG. 6-7, to prevent water intrusion into the vehicle bed. Other constructions could be built without these channels and diversion components but would make it more difficult to keep water from reaching the contents of the vehicle bed. The structure of the cover would also be diminished without forming this geometry and would negatively affect the gasket 512 compression and structural attachment to the vehicle bed.

The bottom flange of the center panel 570 is placed in the water diversion channel of the front panel 511 to locate and support it across the bed of the vehicle, FIG. 15. The same connection is also made with the center panel water diversion channel and the rear panel 530.

Each water diversion channel ends with a water diversion component 502, FIG. 20. This component serves several purposes. It provides an unimpeded drain for each of the water diversion channels on both sides of the vehicle bed, FIG. 7. They also limit the amount of compression of the gaskets 512 used to seal the cover to the vehicle bed. Limiting the compression of the gaskets 512, reducing water penetration and helping the gaskets 512 last longer by eliminating damage from flattening them out.

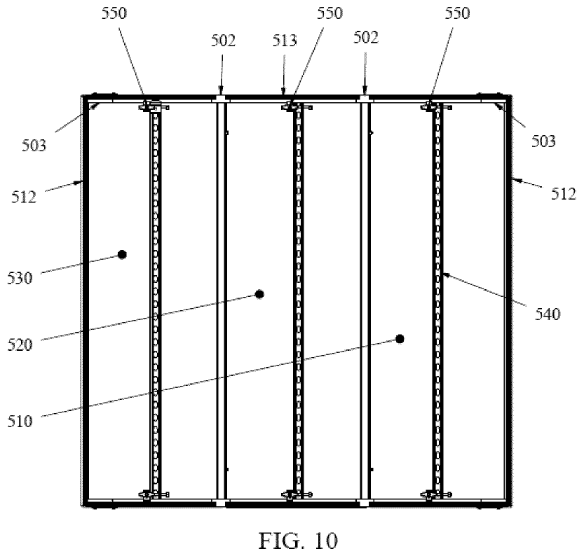

The clamping limit to the vehicle benefits when heavy loads are carried by not allowing the gaskets 512 to compress further due to the water diversion components 502 shown in FIG. 7. The water diversion components 502 divert any water to the exterior of the cover and beyond the gaskets 512 and prevent any intrusion to the interior of the vehicle bed. The gaskets 512 are also affected in the (4) corners of the tonneau cover by limiting spacers 503, shown in FIGS. 10 & 15. The limiting spacers 503 prevent the gaskets 512 from flattening due to over compression on the tailgate of the vehicle. This allows the tailgate to continue to operate freely even when transporting heavy loads on top of the tonneau cover by reducing the friction area of the gaskets 512.

Each corner of the front/rear panels 510/530 have holes for attaching tie downs 501 or an additional gear rack. The location of these holes in conjunction with the geometry of the panels and the shape of the enclosed tie down brackets 501, FIG. 7, keeps the brackets below the top surface of the cover, FIG. 8-9. This reduces the chances of damaging the tie down brackets 501 when loading gear. The geometry of the tie down brackets 501 allows the use of tie down straps or rope to be used to secure gear to the top of the cover.

The enclosed tie down brackets 501 further improve the ability to secure gear to the top of the cover while minimizing damage to them. The panel geometry shown in FIGS. 6-9 includes vertical flat faces providing a mounting surface for racks, strap brackets or other gear not considered. Varying other panel geometries could be used to construct the cover but would not include the same benefits. The vertical faces remove the need to add holes to the top of the cover for mounting rack systems, headache racks or other equipment.

The panels are sized so they can be removed entirely from the vehicle and placed in the vehicle bed as shown in FIG. 4. This allows the user to easily adjust to the gear size/shape they need to haul. The embodiments describing the invention are specific, but other variations or modifications can be made within the scope of this design. One such variation would be to use panels that are full bed rail width and may or may not contain water diversion channels.

The combination of 3 panels, as shown in FIGS. 1 & 5, allows for one person assembly of the cover on the vehicle bed. Similar combinations of more or less than 3 panels can be used to construct the Rigid Panel Tonneau Cover based on the vehicle bed length.

In the enclosed embodiments, structural channels 540 can be used to attach gear and tools to the interior of the tonneau cover panels. The structural channels 540 in the present invention are extruded but can be formed from sheet metal or other materials to match the structural improvements to the cover. The present invention includes the extruded channels as providing the most benefits to attaching additional gear and gear storage drawers while simplifying the manufacturing process.

FIG. 16 displays the locations of structural channels 540 on the interior of the cover panels 510, 520 and 530. The enclosed embodiment uses the clamp assembly 550, shown in FIG. 19, for attaching the cover to the vehicle bed. The clamp assembly 550 is installed to the structural channels using holes in the channel using the rod 551 and a nut 550 or cap to maintain the connection. Turning the knob 553 allows the clamp to tight or loosen the bed rail groove piece 552 on the edge of the bed rail to maintain connection to the vehicle bed.

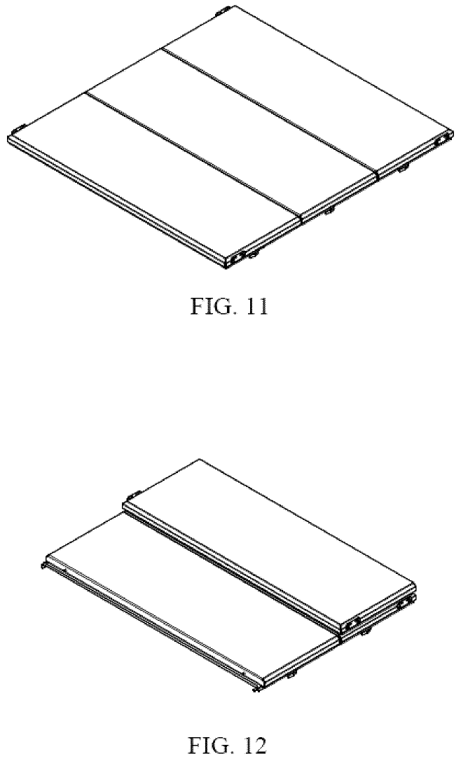

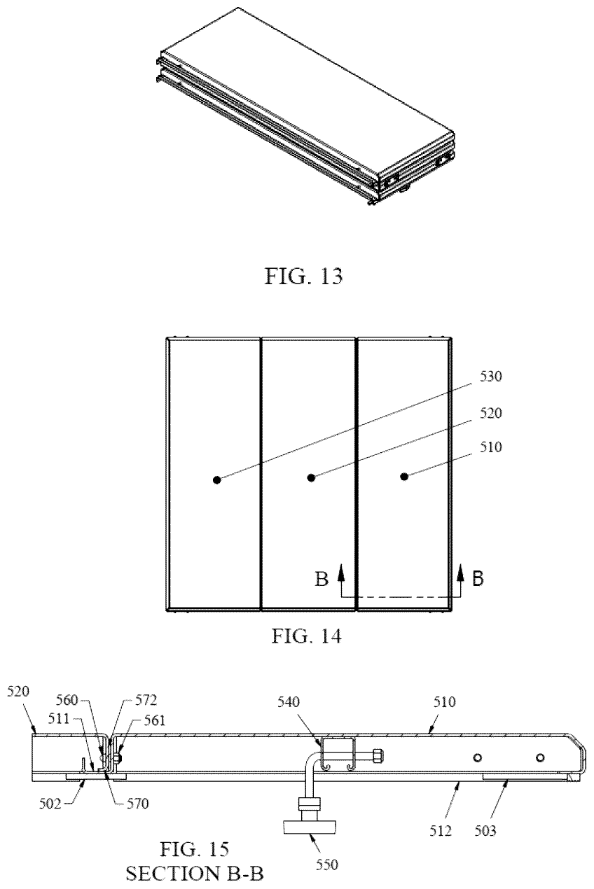

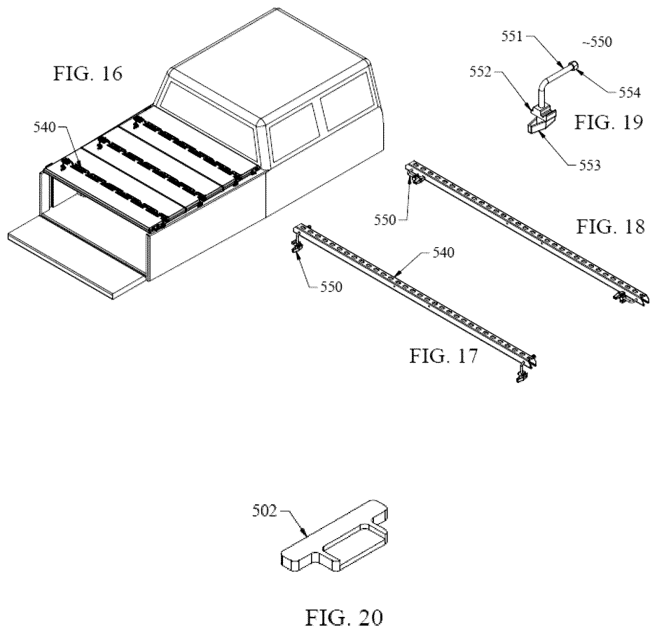

The rod 551 allows the clamp assembly 550 to connect rotationally to the structural channels 540 and rotates to the clamped position for attachment to the vehicle bed, FIGS. 15 & 17 or rotate to the removal position displayed in FIG. 18. The removal position keeps the clamp assembly 550 from damaging the panels when stacked on one another as in FIGS. 2-4 and FIGS. 12-13.

The clamp assembly 550 is shown due to the described benefits and is not intended to limit the use of standard clamping methods for existing tonneau covers and caps to attach the cover to the vehicle bed. Other clamps or brackets and locations can be used to attach the tonneau cover to the vehicle bed, but the benefits shown wherein they remain attached to the cover would not be provided.

Gaskets 512 line the bottom of the panels on the perimeter to seal the cover to the vehicle bed, FIG. 7-9. The gaskets 512 can be a multitude of materials and types with the preferred embodiment being bulb seals. The clamp assembly 550 applies a clamping force to hold the cover to the vehicle bed and engage the gaskets 512 while the water diversion components 502 limit the compression.

On the gutter portion of the rear panel 510 and the center panel 520 there are pins 560 with threaded ends and nuts 561. The pins 560 align with holes in the flange 570 that sit in the water diversion channels 511. The engagement of the pins 560 in these holes further protects against items in the bed being stolen by keeping the panels connected to one another. Working in conjunction with the clamp assemblies 550, the tonneau cover protects items stored within the vehicle bed.

1. A tonneau cover comprising, a series of panels covering a vehicle bed, a front, center and rear panel structurally attached to a vehicle bed, providing security from theft and protection from the elements.

2. The front, center and rear panels of claim 1, wherein the panels are constructed of aluminum, and are connected to structural members to support additional loads.

3. The tonneau cover of claim 1, further comprising, individual panels that can be removed to provide ⅓^{rd}, ⅔^{rd}, or full bed access, and fit inside the vehicle bed or cab of the truck for storage and transport.

4. The front, center and rear panels of claim 1, wherein the panels are attached to the vehicle bed using clamps, and allow easy removal of each panel when desired, and provide adequate structural connection to the vehicle bed to allow the transportation of additional gear or equipment on top of the cover.

5. The structural members of claim 2, wherein a strut channel extrusion is used as the structural members, and the channels have a geometry suited for the attachment of tools and additional gear.

6. The panels of claim 1, further comprising, channels formed for additional strength, and divert water to the exterior of the vehicle bed, and the channels are connected to water diversion components to prevent water from entering the vehicle bed.

7. The water diversion components of claim 6, wherein the components are designed to limit water intrusion, and the components limit compression of the perimeter gaskets, and provide a structural connection to the vehicle bed.

8. The panels of claim 1, further comprising, a smooth exterior top surface so as not to impede the placement of gear on top, and do not have any protruding members required for connection to one another or for locking.
